(19) United States
(12) Patent Application Publication
(10) Pub. No.: US 2007/0222685 A1
(43) Pub. Date: Sep. 27, 2007

(54) Antenna architecture and wireless tracking device using the same

(76) Inventor: Shih-Ti Kuo, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/727,224

(22) Filed: Mar. 26, 2007

(30) Foreign Application Priority Data
Mar. 25, 2006 (TW) 095111035
Feb. 5, 2007 (TW) 096104002

(51) Int. Cl. H01Q 1/38; H01Q 1/48

(52) U.S. Cl. 343/700 MS; 343/846

(57) ABSTRACT

An antenna architecture comprises a base and a plurality of micro antennas. The base comprises of a plurality of reflectors disposed adjacent to edges of the base. The plurality of micro antennas are disposed on the base adjacent to corresponding plurality of reflectors respectively for receiving wireless communication signals within a designated area. Further, the invention provides a wireless tracking device comprises antenna architecture, a converter, a wireless receiver module and a processor. The antenna architecture comprises of a plurality of micro antennas for receiving wireless communication signals within a designated area. The converter is coupled to the micro antennas for processing received signals. The wireless receiver module is coupled to the converter for converting received wireless communication signals into digital data. The processor is coupled to the wireless receiver module for generating position data corresponding to the wireless communication signals according to the digital data.

### BACKGROUND OF THE INVENTION

1. Field of the Invention

The present invention relates to wireless positioning techniques, more particularly, this invention relates to an antenna architecture having direction recognition function and a wireless tracking device using the antenna architecture.

2. Description of Related Arts

In addition to functions and industrial designs, mobility and convenient to carry now have become an important design focus for current wireless communication electronic devices such as cellular phones, wireless area network device, global position systems, and blue tooth communication device. For critical radio frequency passive components providing the receiving and transmitting functions, such as antenna, filters and oscillators, the technical development is also in line with above changes. From a hardware perspective, the new designs in a cellular phone include color displays, polyphonic ring tones, folding phones, and dual displays. From a software perspective, the new designs in a cellular phone include General Packer Radio Service (GPRS), Multimedia Messaging Service (SMS) and services integrating Bluetooth function, personal digital assistant functions. These new designs demand massive computing operations and complicated communication circuitry, which gives less space for disposing radio frequency passive components in a wireless communication device. In addition, the operation of the circuits generates electronic magnetic interference to the frequency passive component. Although wireless area network is stationary mobile application, users demand for compact and light designs on a mobile device remain the same.

The advancement of technology in ceramic path antenna is rapid in recent years. Because of the compact design and low cost advantages, ceramic micro antennas (chip antenna) using low-temperature co-fired ceramics (LTCC) manufacturing process has become a popular antenna option in concealed antenna designs in cellular phones and wireless area network applications.

A unidirectional antenna is conventionally capable of detecting the distance and direction of an object to be tracked. However, the detected direction is not reliable due to errors caused by mal-operations and interference from the environment. Further, the conventional wireless tracking system detects the direction and distance by utilizing several directional antennas. Such high directional antennas are mainly patch antennas and huge in volume, which do not meet the concealed and compact design requirements of wireless applications.

### SUMMARY OF THE INVENTION

It is therefore an objective of the present invention to provide an antenna architecture providing direction recognition function and wireless tracking device using the antenna architecture, wherein the antenna architecture can be integrated into the wireless tracking device.

It is another objective of the present invention to provide an antenna architecture providing direction recognition function and wireless tracking device using the antenna architecture, wherein the antenna architecture is formed by micro antennas and the antenna architecture can be integrated into a compact mobile device for detecting the wireless signal source. Such antenna architecture is adapted to the compact and invisible design requirements for a wireless tracking device.

It is yet another objective of the present invention to provide an antenna architecture providing direction recognition function and wireless tracking device using the antenna architecture, wherein the micro antennas receive wireless communication signals from the signal sources within a designated area by providing several reflectors on the micro antennas so as to locate the position an object to be tracked.

In order to achieve the above purpose, the present invention provides an antenna architecture comprising a base having a plurality of reflectors disposed adjacent to edges of the base and a plurality of micro antennas disposed on the base and disposed adjacent to corresponding the plurality of reflectors respectively for receiving wireless communication signals within a designated area.

Further, the present invention provides a wireless tracking device comprising an antenna architecture providing direction recognition function, a converter, a wireless receiver module, and a processor. The antenna architecture comprises a plurality of micro antennas for receiving wireless communication signals within a designated area. The converter is coupled to the micro antennas for processing the received wireless communication signals. The wireless receiver module is coupled to the converter for converting the received wireless communication signals into digital data. The processor is coupled to the wireless receiver module for generating position data corresponding to the wireless communication signals according to the digital data.

### BRIEF DESCRIPTION OF THE DRAWINGS

FIG. 1 illustrates a top view of one preferred embodiment of an antenna architecture having direction recognition function according to the present invention;

FIG. 2 illustrates a partial enlarged view of the portion adjacent to the micro antenna 11 in FIG. 1;

FIG. 3 illustrates a top view of another preferred embodiment of an antenna architecture having direction recognition function according to the present invention; and

FIG. 4 illustrates a block diagram of an embodiment of the wireless tracking device according to the present invention.

### DETAILED DESCRIPTION OF THE PREFERRED EMBODIMENTS

Embodiments are provided in the following to illustrate an antenna architecture having direction recognition function and a wireless tracking using the antenna architecture according to the present invention. Same notation refers to the same or similar components or device.

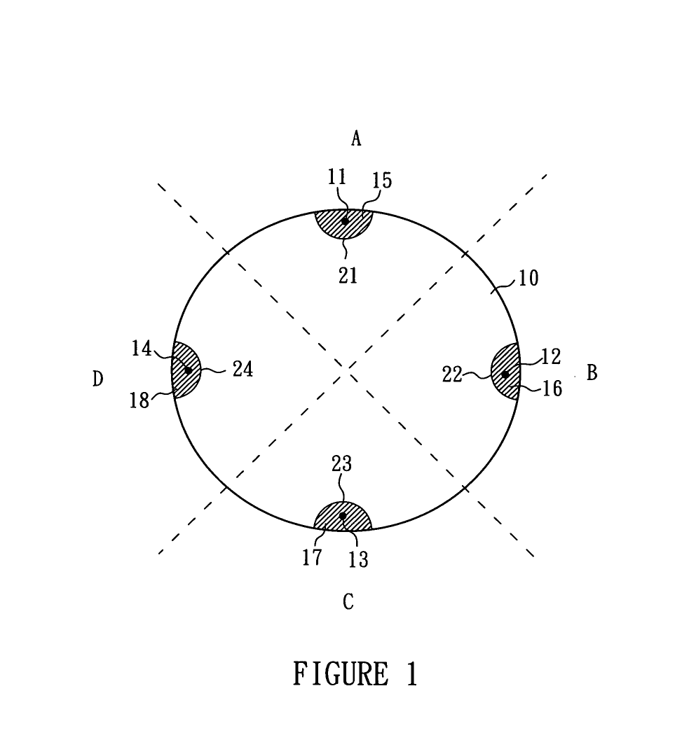

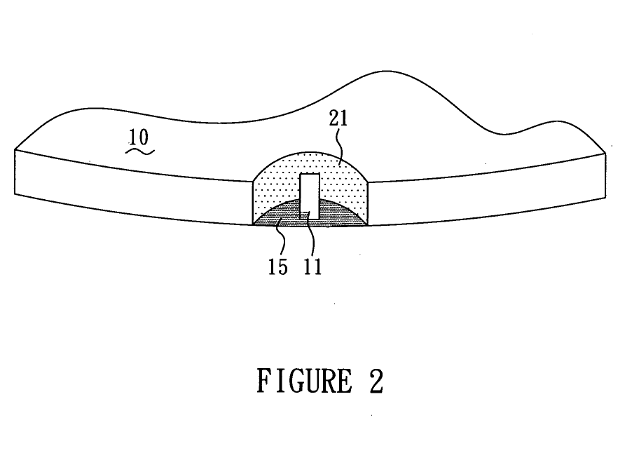

Referring to FIGS. 1 and 2, FIG. 1 illustrates a top view of an preferred embodiment of an antenna architecture having direction recognition function and FIG. 2 illustrates a partial enlarged view of the portion adjacent to the micro antenna 11 in FIG. 1 according to the present invention. As shown in FIG. 1, an antenna architecture 1 having direction recognition function has a plurality of micro antennas. In this embodiment, those antennas are expressed as four micro antennas 11, 12, 13, 14. The scope of the present invention is not limited to the above. In FIG. 1, a base 10 can be a chip, PCB substrate or other circuit board. In the present embodiment, the shape of the base 10 is circular; however, the scope of the invention is not limited to the present embodiment. Preferably, recesses 15, 16, 17, 18 are disposed on the base 10 for receiving micro antennas 11, 12, 13, 14 respectively. The micro antennas 11, 12, 13, 14 can be multi-layer ceramic chip antennas, plastic chip antennas or other forms of micro antennas.

Referring to FIG. 1, the recesses 15, 16, 17, 18 are disposed at the edge of the base 10. The side walls of recesses 15, 16, 17, 18 correspond to the micro antennas 11, 12, 13, 14 are coated with reflective materials or the side walls themselves are reflective such that reflectors 21, 22, 23, 24 are formed respectively. The reflective material used for coating can be conductive materials such as metal or other reflective materials. The reflectors 21, 22, 23, 24 are used for having wireless communication signals focus on a designated direction and enhance the strength of wireless communication signals while received or transmitted. In addition, the reflectors 21, 22, 23, 24 are used as grounding interfaces to shield the wireless communication signals. As such, the micro antennas 11, 12, 13, 14 are employed for receiving or transmitting wireless communication signals. The reflectors 21, 22, 23, 24 are used to facilitate the micro antennas 11, 12, 13, 14 for receiving or transmitting wireless communication signals from designated directions. As shown in the FIG. 1, the micro antenna 11 is used for transmitting or receiving wireless communication signals from area A, the micro antenna 12 is used for transmitting or receiving wireless communication signals from area B, the micro antenna 13 is used for transmitting or receiving wireless communication signals from area C, and the micro antenna 14 is used for transmitting or receiving wireless communication signals from area D.

The area A, B, C, D used in the FIG. 1 is used as a figurative means to demonstrate the embodiment, the field coverage and pattern of each area depend on the aperture rate of the reflectors 11, 12, 13, 14 and strength of the wireless communication signals.

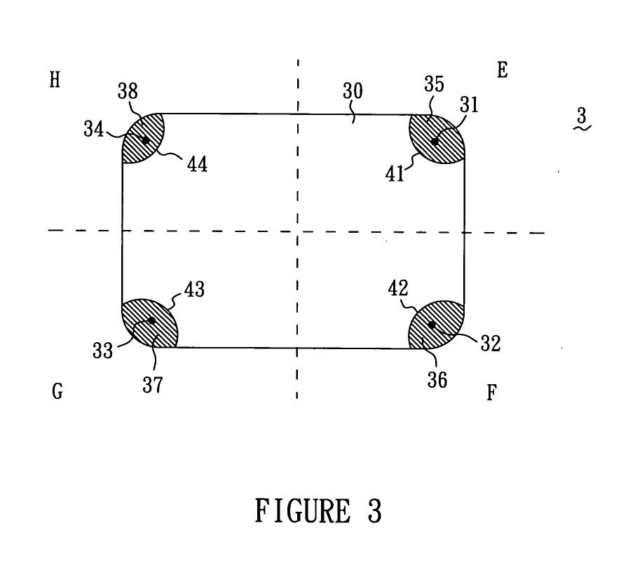

FIG. 3 illustrates a top view of another embodiment of an antenna architecture having direction recognition function according to the present invention. As shown in FIG. 3, according to the present invention, an antenna architecture 3 having direction recognition function has a plurality of micro antennas, which is expressed as micro antennas 31, 32, 33, 34, the scope of the present invention is not limited as above. The base 30 can be a chip, PCB substrate or other circuit board. In the present embodiment, the shape of the base 30 is rectangular; however, the scope of the invention is not limited to the present embodiment. The micro antennas 31, 32, 33, 34 are disposed on the four corners of the base 30. Preferably, recesses 35, 36, 37, 38 are disposed on the base 30 for receiving micro antennas 31, 32, 33, 34 respectively. The micro antennas 31, 32, 33, 34 can be multi-layer ceramic multi-layer ceramic chip antennas, plastic chip antennas or other forms of micro antennas.

Referring to FIG. 3, the recesses 35, 36, 37, 38 are disposed at the corners of the base 30. The side walls of recesses 35, 36, 37, 38 correspond to the micro antennas 31, 32, 33, 34 are coated with reflective materials such that reflectors 41, 42, 43, 44 can be formed respectively. The reflective material used for coating can be conductive materials such as metal or other reflective materials. The reflectors 41, 42, 43, 44 are used for having wireless communication signals focus on a designated direction and enhance the strength of wireless communication signals while received or transmitted. In addition, the reflectors 41, 42, 43, 44 are used as grounding interfaces to shield the wireless communication signals. As such, the micro antennas 31, 32, 33, 34 are employed for receiving or transmitting wireless communication signals. The reflectors 41, 42, 43, 44 corresponding to the micro antennas 31, 32, 33, 34 are used for receiving or transmitting wireless communication signals from/to a designated direction. As shown in the FIG. 3, the micro antenna 31 is used for transmitting or receiving wireless communication signals from area E, the micro antenna 32 is used for transmitting or receiving wireless communication signals from area F, the micro antenna 33 is used for transmitting or receiving wireless communication signals from area G, and the micro antenna 34 is used for transmitting or receiving wireless communication signals from area H.

The area E, F, G, H used in the FIG. 3 is used as a figurative means to demonstrate the embodiment, the field coverage and pattern of each area depend on the aperture rate of the reflectors 41, 42, 43, 44 and strength of the wireless communication signals.

Further, the micro antennas used in embodiments illustrated in FIG. 1 and FIG. 3 are disposed on the same plane. However, the scope of the present invention also covers the application where the micro antennas are disposed on different planes to so as the position tracking is provided with three dimensional position capabilities.

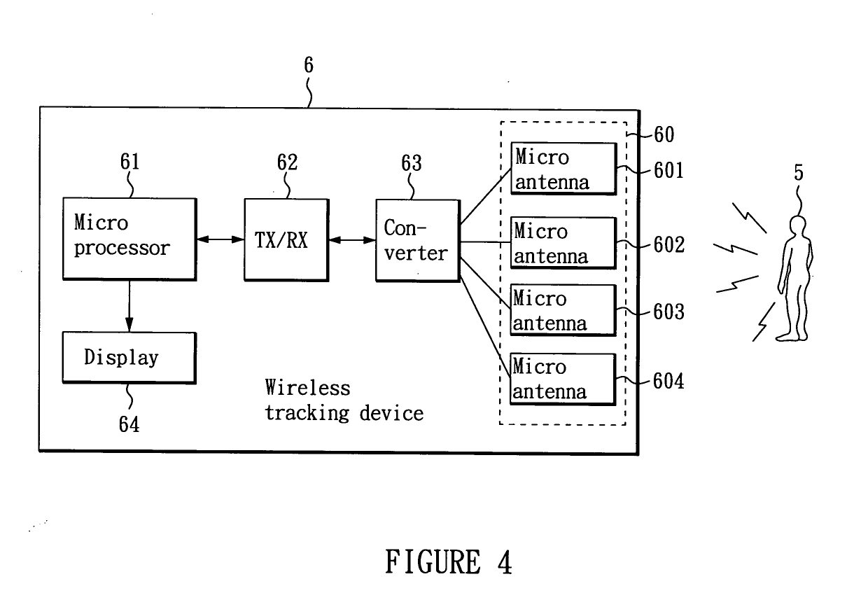

FIG. 4 illustrates a block diagram of an embodiment of the wireless tracking device according to the present invention. As shown in FIG. 4, a wireless tracking device 6 according to the present invention is used for detecting at least one object 5. The object 5 can be an active device, carried by a person, such as a Zigbee, WLAN device or radio-frequency identification (RFID) device. Especially, a passive RFID device has an ability of converting the received radio frequency into power and thereafter transmitting identification code stored therein by using that power. Accordingly, the object 5 bearing the passive RFID device can be tracked without batteries or power supplies.

In FIG. 4, the mobile wireless tracking device 6 comprises an antenna architecture 60 having direction detection function, a processor 61, a wireless transceiver module 62, a converter 63, and a display unit 64. The micro processor 61 is used for program execution and data computing required for controlling the wireless tracking device. The wireless transceiver module 62 is electrically coupled to the micro processor 61 for receiving or transmitting the wireless communication signals. The signal processing completed by the wireless transceiver module 62 includes signal modulation, signal demodulation, signal down-conversion or signal up-conversion. The antenna architecture 60 further comprises a plurality of micro antennas 601, 602, 603, 604. The detailed structure of the micro antennas 601, 602, 603, 604 are similar to the micro antennas used in embodiments illustrated in the FIG. 1 and FIG. 3. The micro antennas 601, 602, 603, 604 are all coupled to converter 63. The converter 63 control the designated areas detected by individual micro antennas 601, 602, 603, 604. The converter 63 transmits the received wireless communication signals (sent from object 5) to the wireless transceiver module 62. The wireless transceiver module 62 converts the received signals from the micro antennas 601, 602, 603, 604 into digital packet data. The converted digital packet data ate thereafter transmitted to the micro processor 61. Alternatively, the wireless transceiver module 62 receives the digital packet data from the micro processor 61 and converts the digital packet data into the electric signals. Then, the electric signals are transmitted by the micro antennas 601, 602, 603, 604 to the object 5. According to the embodiments demonstrated in FIG. 1 and FIG. 3, the detecting areas of the micro antennas 601, 602, 603, 604 are evenly distributed by angles around 360 degrees on a plane. Alternatively, the micro antennas can be distributed in different planes to enable three dimensional tracking of the object 5. The display unit 64 is used as user interface to receive the data of the micro processor 61 for display the communication status as well as the direction and distance of the mobile object 5.

Therefore, the antenna architecture having the direction recognition function and the wireless tracking device using the antenna architecture disclosed utilize a plurality of micro antennas for detecting the strength and direction of the wireless communication signals to recognize the direction and distance between the antennas and the detect target device.

Although the description above contains much specificity, it should not be construed as limiting the scope of the invention but as merely providing illustrations of some of the presently preferred embodiments of the present invention. Thus, the scope of the present invention should be determined by the appended claims and their equivalents, rather than by the examples given.

What is claimed is:

1. An antenna architecture comprising:
a base comprising of a plurality of reflectors disposed adjacent to edges of said base; and
a plurality of micro antennas disposed on said base and disposed adjacent to corresponding said plurality of reflectors respectively for receiving wireless communication signals within a designated area.

2. The antenna architecture of claim 1, wherein said base further comprises a plurality of recesses such that said plurality of reflectors are disposed on side walls of corresponding said plurality of recesses respectively.

3. The antenna architecture of claim 2, wherein said reflectors are composed of a kind of conductive material.

4. The antenna architecture of claim 3, wherein said conductive material is metal.

5. The antenna architecture of claim 2, wherein said reflectors are grounding planes.

6. The antenna architecture of claim 1, wherein said micro antennas are multi-layer ceramic chip antennas.

7. The antenna architecture of claim 1, wherein said micro antennas are plastic chip antennas.

8. A wireless tracking device comprising:
an antenna architecture having direction recognition function comprising of a plurality of micro antennas for receiving wireless communication signals within a designated area;
a converter coupled to the micro antennas for processing said received wireless communication signals;
a wireless receiver module coupled to said converter for converting said received wireless communication signals into digital data; and
a processor coupled to said wireless receiver module for generating position data corresponding to said wireless communication signals according to said digital data.

9. The wireless tracking device of claim 8, wherein said antenna architecture further comprises a base having a plurality of reflectors disposed adjacent to edges of said base, and said micro antennas are disposed on said base adjacent to corresponding said plurality of reflectors respectively.

10. The wireless tracking device of claim 9, wherein said plurality of reflectors are disposed on side walls of corresponding said plurality of recesses.

11. The wireless tracking device of claim 10, said reflectors are composed of a kind of conductive material.

12. The wireless tracking device of claim 11, wherein said conductive material is metal.

13. The wireless tracking device of claim 9, said reflectors are grounding planes.

14. The wireless tracking device of claim 8, wherein said micro antennas are multi-layer ceramic chip antennas.

15. The wireless tracking device of claim 8, wherein said micro antennas are plastic chip antennas.

16. The wireless tracking device of claim 8, further comprising a display unit coupled to said processor for displaying said position data.
